(19) United States
(12) Patent Application Publication
(10) Pub. No.: US 2005/0060090 A1
(43) Pub. Date: Mar. 17, 2005

(54) Vehicle-type measurement system

(76) Inventor: Kouji Sasano, Tokyo (JP)

Correspondence Address: LADAS & PARRY LLP, 224 SOUTH MICHIGAN AVENUE, SUITE 1200, CHICAGO, IL, 60604, US

(21) Appl. No.: 10/664,382

(22) Filed: Sep. 17, 2003

(51) Int. Cl. G01C 21/28

(52) U.S. Cl. 701/213; 342/357.14

(57) ABSTRACT

A light from a light source is irradiated to a target position, and the position of the irradiated light is displayed on a screen. A driver moves a vehicle-type measurement system so that the light is kept irradiated to the target position. While the vehicle-type measurement system is moving, a GPS receiver outputs GPS measurement data indicating the position of the vehicle-type measurement system based on a signal from a GPS antenna, and the data is stored in a storage medium. Thus, by moving the vehicle-type measurement system so that the light is kept irradiated to the target position, the GPS measurement data which indicates a position of a predetermined distance from the target position can be continuously measured.

### BACKGROUND OF THE INVENTION

1. Field of the Invention

The present invention relates to a vehicle-type measurement system utilizing GPS (Global Positioning System).

2. Description of Related Art

In the past, geographic position information used as a base of map data was measured by a time-consuming system utilizing a transit. On the other hand, recently, a measurement technique utilizing GPS is common in order to obtain map information.

GPS measurement is a technique for calculating a terrestrial position with high accuracy by executing multiple matrix arithmetic operation of data which are simultaneously received from multiple satellites. In recent years, measurement accuracy has been improved by a technique called “DGPS (differential GPS)”. There are two systems in DGPS, i.e., a code differential system which executes correction by a transmission code of a signal, and RTK (Real Time Kinematik) which improves accuracy by utilizing a phase difference between QPSK signal carrier waves of GPS satellites. In the RTK measurement system, by transmitting position correction data from a base station to a measurement point, accuracy of several-centimeter order can be obtained within a radius of about 10 km from the base station.

Accordingly, if an environment in which correction data from the base station can be continuously obtained in a movable body such as a vehicle is realized, highly accurate and effective geographic data measurement as described above is possible by executing the measurement while moving the vehicle.

### SUMMARY OF THE INVENTION

The present invention has been achieved in order to solve the above problems. It is an object of this invention to efficiently produce highly accurate map data by utilizing GPS in a movable body such as a vehicle.

According to one aspect of the present invention, there is provided a vehicle-type measurement system including a light source which irradiates a light to a target position while traveling, a screen which displays a position of the irradiated light to the target position, a GPS antenna, a GPS receiver which is connected to the GPS antenna and outputs GPS measurement data, and a data storing unit which stores the GPS measurement data output from the GPS receiver in a storage medium.

According to the vehicle-type measurement system, the light from the light source is irradiated to the target position, and the position of the irradiated light is displayed on the screen. A driver moves the vehicle-type measurement system so that the light is kept irradiated to the target position. While the vehicle-type measurement system is moving, the GPS receiver outputs the GPS measurement data indicating the position of the vehicle-type measurement system based on the signal from the GPS antenna, and the data is stored in the storage medium. Thus, by moving the vehicle-type measurement system to make the light keep irradiated to the target position, the GPS measurement data which indicates the position of the predetermined distance from the target position can be continuously measured.

The vehicle-type measurement system according to one feature may include a correction data receiver which receives correction data of the GPS measurement data, and the GPS receiver may correct the GPS measurement data by utilizing the correction data. In this feature, highly accurate GPS measurement data can be stored by utilizing the correction data with a technique of the RTK, for example.

The vehicle-type measurement system according to another feature may include a display device which displays map data in a neighborhood of a current position of the vehicle-type measurement system, and a measurement position display unit which displays a measurement position, based on the GPS measurement data, on the display device. Thus, the GPS measurement data can be displayed on the map data.

The vehicle-type measurement system according to still another feature may include the data storing unit which stores the GPS measurement data in the storage medium in a manner associated with place name. Thus, the GPS measurement data can be searched by utilizing the place name.

The vehicle-type measurement system according to still another feature may further include an image-capturing device which captures a neighboring image, and the data storing unit may store image data captured by the image-capturing device in the storage medium in a manner associated with the GPS measurement data. Thus, the captured image data of the corresponding position can be stored together with the GPS measurement data.

According to another aspect of the present invention, there is provided a vehicle-type measurement system including, a light source which irradiates a light to a top of a target object while traveling, a screen which displays a position of the irradiated light to the top of the target object, an angle detection unit which detects an emission angle of the light, and a calculation unit which calculates height of the target object based on the emission angle, a distance between the vehicle-type measurement system and the target object, and height of the vehicle-type measurement system.

The vehicle-type measurement system moves at the position of the predetermined distance to the target object. The light from the light source is controlled so that the light is always irradiated to the top of the target object, and the emission angle of the light at that time is detected. Based on the emission angle, the distance between the vehicle-type measurement system and the target object, and the height of the vehicle-type measurement system, the height of the target object is calculated.

The vehicle-type measurement system according to one feature may include a GPS antenna, a GPS receiver which is connected to the GPS antenna and outputs GPS measurement data, and a data storing unit which stores GPS measurement data output from the GPS receiver in a storage medium together with the calculated height of the target object. According to this feature, the GPS measurement data in the constant distance from the target object and the height of the target object can be stored in a manner associated with each other.

### BRIEF DESCRIPTION OF THE DRAWINGS

FIG. 1 schematically shows a motion of a vehicle-type measurement system according to the embodiment of the present invention.

FIG. 2 is a block diagram showing a configuration of the vehicle-type measurement system shown in FIG. 1.

FIG. 3 shows data which is stored in a vehicle-type measurement system.

FIG. 4 shows a display example of a measurement route during measurement.

FIG. 5 is a flow chart showing a measurement processing.

FIG. 6 is a flow chart of a traveling processing.

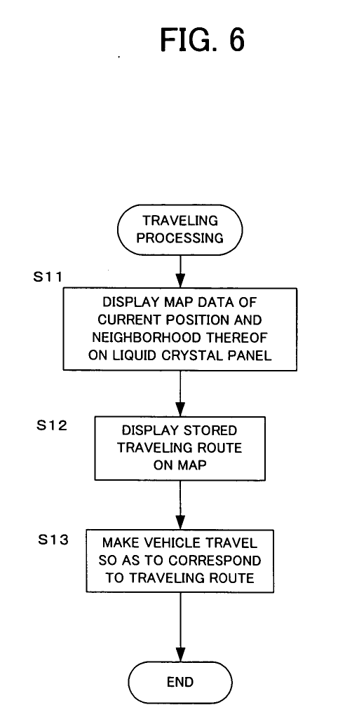

FIG. 7 conceptually shows a motion of a vehicle-type measurement system according to the second embodiment of the present invention.

FIG. 8 conceptually shows a motion of a vehicle-type measurement system according to the third embodiment of the present invention.

### DETAILED DESCRIPTION OF THE PREFERRED EMBODIMENTS

The preferred embodiments of the present invention will now be described below with reference to the attached drawings.

[1st EMBODIMENT]

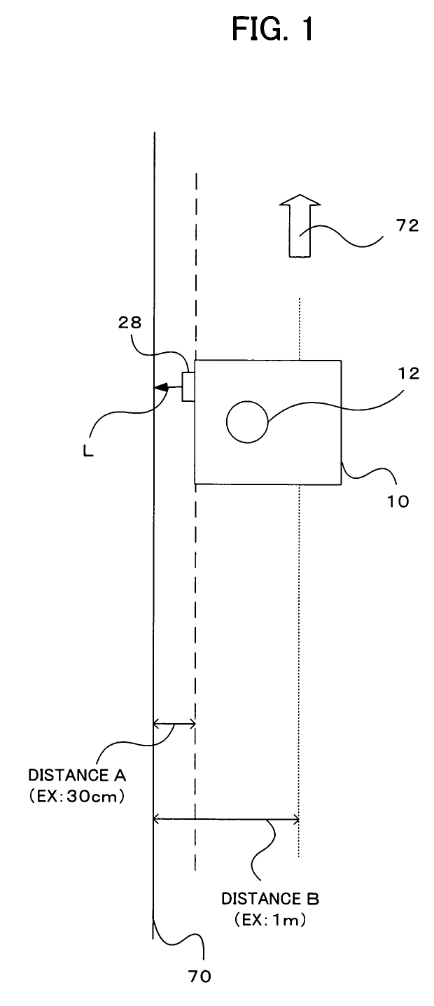

FIG. 1 schematically shows a motion of a vehicle-type measurement system according to the first embodiment of the present invention. The vehicle-type measurement system in the present invention continuously measures a position of a predetermined distance from a road edge with high accuracy by moving a vehicle. Measurement data measured in that way can be utilized as auxiliary data in producing highly accurate map data.

Also, the vehicle-type measurement system of the present invention can be preferably applied to the snow removal work in a snowfall area, for example. In an area where roads are covered with snow in winter, work for removing the snow lying thick on the roads is performed by a snowplow. However, in such a situation, it is difficult to determine road edges because of snow. As a result, an accident, e.g., a fall of a snowplow into a ditch of the road edge, can happen. Therefore, if a traveling route along the road edge or along the position with a predetermined distance from the road edge is measured, in advance, in no-snow season, and the work for removing the snow is performed dependently on traveling route data thereof during snow-falling, the accident such as a fall of a snowplow can be prevented.

In FIG. 1, a vehicle-type measurement system 10 is provided with measuring equipments loaded on the vehicle. The measuring equipments will be described below. The vehicle-type measurement system 10 includes a light source 28 which emits a spotlight or a laser light (it is called “light” below) L, and the light L is irradiated on the road near a road edge 70. In this example, the light source 28 irradiates the light L to a 30-centimeter-outside position from an edge point of the vehicle-type measurement system 10.

A GPS antenna 12 is attached to the vehicle-type measurement system 10, and a position coordinate of the GPS antenna 12 is calculated by receiving waves from satellites. Now, provided that the GPS antenna 12 is attached at a horizontal position which is 70 cm remote from an edge point of a road edge side of the vehicle-type measurement system 10, GPS measurement data (latitude data and longitude data) calculated from the waves which the GPS antenna 12 receives is the position data which is 1 m remote from the road edge 70. Thus, by making the vehicle-type measurement system 10 travel so that the light L always irradiates the road edge 70, the position of coordinate which is 1 m remote from the road edge 70 can be continuously measured.

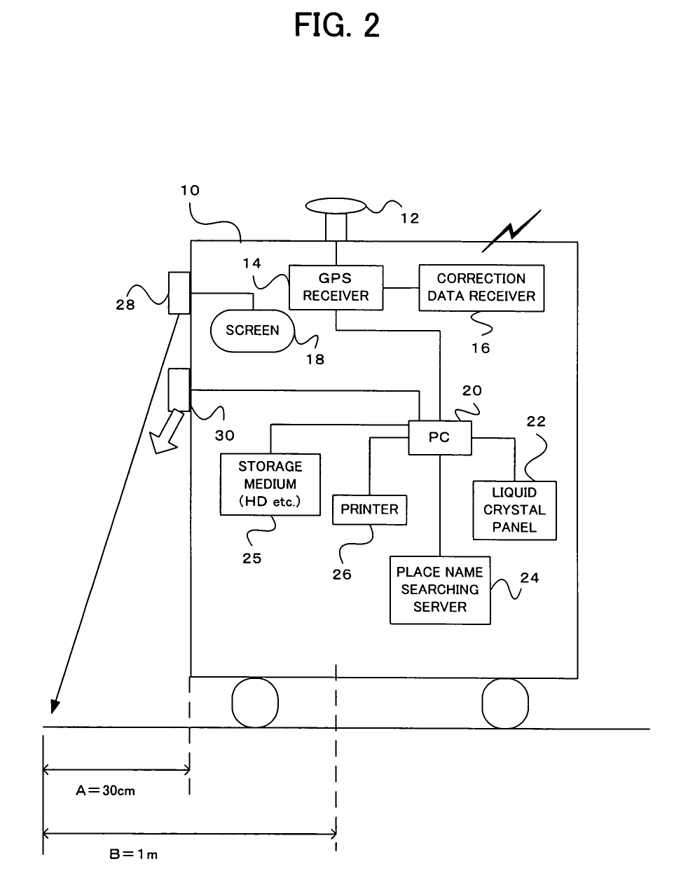

FIG. 2 shows a configuration of the vehicle-type measurement system 10. As shown in FIG. 2, the vehicle-type measurement system 10 includes a GPS receiver 14 connected to the GPS antenna 12 and a correction data receiver 16 connected to the GPS receiver 14. The GPS receiver 14 executes matrix arithmetic operation based on the waves received by the GPS antenna 12, and calculates geographic position information (latitude and longitude) data of the GPS antenna 12. Since the method of calculating the position data by the GPS receiver is well known, the detailed explanation thereof is omitted here.

The correction data receiver 16 receives correction data according to DGPS, and supplies the data to the GPS receiver 14. There can be various transmission methods of the correction data to the correction data receiver 16. For example, by superimposing the correction data to a broadcasting signal from a TV station, the correction data may be transmitted. Also, by communication lines of a portable telephone and a movable body communication, the data may be transmitted. When the correction data is superimposed to the broadcasting signal from the TV station, not only analog broadcasting but also digital broadcasting may work. In a case of the analog broadcasting, VBI (Vertical Blanking Interval) signal may be utilized, and a sub-carrier of a sound multiplex signal may be also utilized. Thus, according to a utilized transmission method, receivers of the portable phone and a broadcasting wave signal can be used as the correction data receiver 16. The GPS receiver 14 utilizes the correction data supplied from the correction data receiver 16 to correct position information.

The vehicle-type measurement system 10 includes a personal computer (PC) 20, a liquid crystal panel 22, a place name searching server 24, a storage medium 25 such as a hard disc, a printer 26 and a video camera 30. The liquid crystal panel 22, the place name searching server 24, the storage medium 25, the printer 26 and the video camera 30 are connected to the PC 20.

The video camera 30 captures an image in a neighborhood of the road edge while the vehicle-type measurement system 10 is traveling, and supplies captured image data to the PC 20. The captured image data may be continuous moving picture data or still picture data at a specific point (e.g., an intersection) during traveling. The PC 20 stores the captured image data, which is supplied from the video camera 30, in the storage medium 25.

In the storage medium 25, map data of an area in which the vehicle-type measurement system 10 is planned to travel is stored in advance. The PC 20 reads out the map data in the neighborhood of a current position from the storage medium 25 and displays the data on the liquid crystal panel 22 while the vehicle-type measurement system 10 is traveling. Therefore, on the liquid crystal panel 22, the map of the neighborhood of the current position is displayed like the manner of a car navigation system, and the current position of the vehicle-type measurement system 10 is displayed on the map.

The place name searching server 24 stores a specific place name with relation to the map data. As stored place names, a lot number of an address, an intersection name and a specific landmark name are included, for example. The GPS measurement data obtained by the GPS receiver 14, which is managed per place name which the place name searching server 24 manages, is stored in the storage medium 25.

The printer 26 has a function of printing out the GPS measurement data stored in the storage medium 25, as a need arises.

A light source 28 provided to the outside of the vehicle-type measurement system 10 includes an optical system such as a mirror and a lens (periscope), which are not shown in FIG. 2, and displays a state of the road edge 70 on which the light L is irradiated on the screen 18. Thereby, a driver or an assistant can confirm whether the light L correctly irradiates the road edge 70 or not. It is noted that an irradiating state of the light L can be displayed on the screen 18 by providing an image-capturing device such as a CCD camera instead of the optical system.

During measurement, when the vehicle-type measurement system 10 travels with the light L from the light source 28 irradiated on the road edge 70, the GPS measurement data is calculated by the GPS receiver 14, and the data is stored in the recording medium 25 via the PC 20. If the GPS measurement data is corrected by the correction data from the correction data receiver 16, the data is measured with high accuracy of about 2 cm by the above-mentioned RTK technique. The PC 20 stores the GPS measurement data in the storage medium 25 together with other various data.

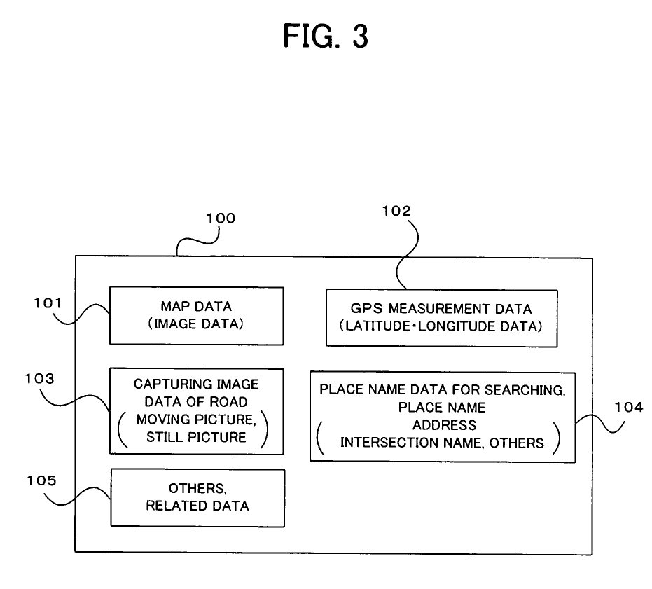

FIG.3 shows an example of the data stored in the storage medium 25. In the storage medium 25, map data 101 of areas in which the vehicle-type measurement system 10 travels is pre-stored. Also, highly accurate GPS measurement data 102 which is supplied from the GPS receiver 14 is stored. In addition, captured image data 103 which is captured by the video camera 30 and related data 105 such as other attribute data and classification data can be stored.

The GPS measurement data 102 and the above various data can be stored in the storage medium 25 in a manner classified by place name data for searching 104. The place name may be, for example, an address and an intersection name, and those place name data are supplied from the place name searching server 24 to the PC 20. In this case, when the measurement in a certain area has been completed and the GPS measurement data 102 in the area is obtained, an operator operates the PC 20, and the GPS measurement data 102, the map data 101, the captured image data 103 and the related data 105 can be stored by grouping them per place name obtained from the place name searching server 24.

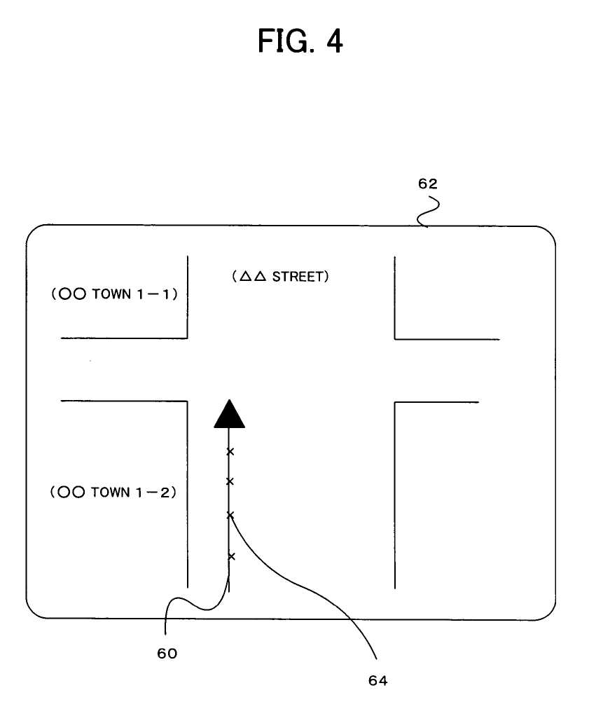

FIG. 4 shows an example of the image displayed on the liquid crystal panel 22 during measurement. On the liquid crystal panel 22, the map data of the area in which the vehicle-type measurement system 10 is traveling is displayed, and the current position of the vehicle-type measurement system is indicated by a triangular mark on the data. Moreover, measurement positions 64 (indicated by “x”) which the GPS measurement data indicates are shown on the map. The measurement position 64 is the position data which is periodically calculated while the vehicle-type measurement system 10 is traveling, and which is stored in the storage medium 25. The set of the data constitutes the locus data which indicates the traveling route 60.

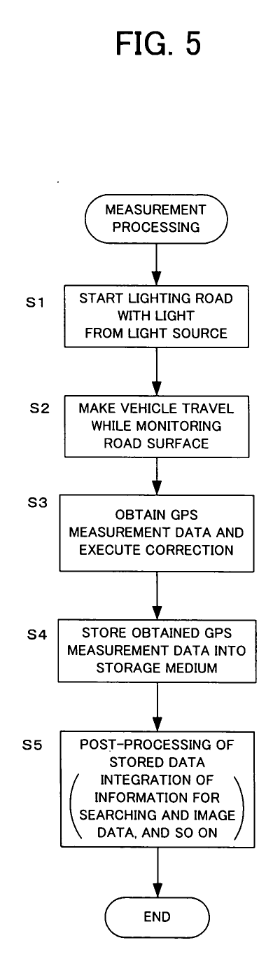

Next, a measurement processing by the vehicle-type measurement system 10 of the present invention will be explained with reference to FIG. 5. FIG. 5 is a flow chart of the measurement processing.

First of all, a driver, or a driver and an assistant operate(s) the light source 28 of the vehicle-type measurement system 10 to emit the light L and to locate the vehicle-type measurement system 10 at a position at which the road edge is irradiated (step S1). Then, the driver, or the driver and the assistant monitor(s) the screen 18 so that the driver or the driver and the assistant drive(s) the vehicle-type measurement system 10 with the light L located on a target road edge (step S2).

As the vehicle-type measurement system 10 travels, the GPS receiver 14 calculates the GPS measurement data, and executes the correction based on the correction data which is supplied from the correction data receiver 16 to supply corrected GPS measurement data to the PC 20 (step S3).

In the PC 20, the GPS measurement data supplied from the GPS receiver 14 is stored in the storage medium 25 (step S4). In that way, the highly accurate GPS measurement data, which is obtained by traveling in a predetermined area, is stored in the storage medium 25. The GPS measurement data thus obtained is the set of each position data as shown in FIG. 4, and the data is stored as the locus data of the traveling route.

Afterward, a post-processing of the stored GPS measurement data is executed as a need arises (step S5). Namely, the GPS measurement data is associated with the place name data for searching, the capturing image data and other data, and is stored in the storage medium 25.

Next, a traveling processing by utilizing traveling route data which is formed and stored in that way will be explained. Now, it is assumed that a snowplow performs snow removal work in winter by utilizing the traveling route data prepared in the above method. Thus, a navigation system is provided to the snowplow in advance.

First, the map data in the neighborhood of the current position of the snowplow is displayed by the navigation system (step S11), and next, prepared traveling route data is supplied to the navigation system to display the traveling route (step S12). A state in which the traveling route is displayed on a display screen of the navigation system is basically identical to a state shown in FIG. 4. Namely, the traveling route 60 is displayed on the map data in the neighborhood of the current position of the snowplow. Then, the driver of the snowplow drives the snowplow along the traveling route 60. Thereby, the snowplow correctly travels the position remote from the road edge by the predetermined distance, and the snowplow can remove snow within the range of the predetermined distance from the road edge.

In that way, according to the first embodiment of the present invention, if the vehicle-type measurement system 10 travels so that the light L is kept irradiated to the target position on the road edge, the GPS measurement data of the position remote from the target position by the predetermined distance can be constantly obtained. The GPS measurement data can be obtained with very high accuracy by the RTK technique utilizing the correction data. By storing the data thus obtained in a manner associated with the captured image data on the road, the operator can see the image in the neighborhood thereof as a need arises. Also, by storing the GPS measurement data in a manner associated with the place name, searching by the place name is possible.

[2nd EMBODIMENT]

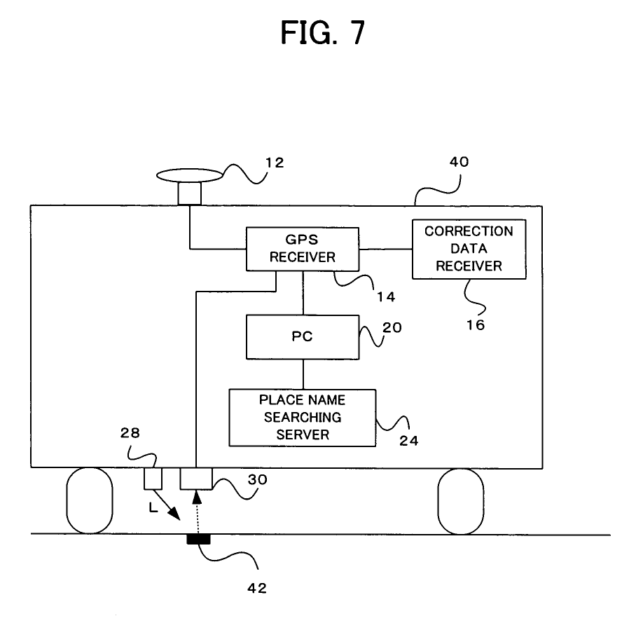

Next, the second embodiment of the present invention will be explained. An example of a configuration of a vehicle-type measurement system 40 according to the second embodiment is shown in FIG. 7. The vehicle-type measurement system 40 according to the second embodiment is identical to the vehicle-type measurement system 10 according to the first embodiment as to a basic configuration. However, the vehicle-type measurement system 10 according to the first embodiment determines the traveling position of the vehicle-type measurement system 10 by irradiating the light L, which is emitted from the light source 28 attached to the side of the system 10, to a target such as a road edge. On the contrary, the vehicle-type measurement system 40 of the second embodiment travels while monitoring a marker 42 formed on the ground from an upper side, by the light source 28 and the video camera 30 attached to a bottom of the vehicle-type measurement system 40. As the marker 42, for example, a traffic lane painted on the road and a border line in a parking area can be utilized.

According to this embodiment, by driving the vehicle-type measurement system 40, the GPS measurement data at a predetermined relative position to the marker 42 can be obtained. The GPS measurement data may be as accurate as that one according to the first embodiment, by utilizing the correction data.

[3rd EMBODIMENT]

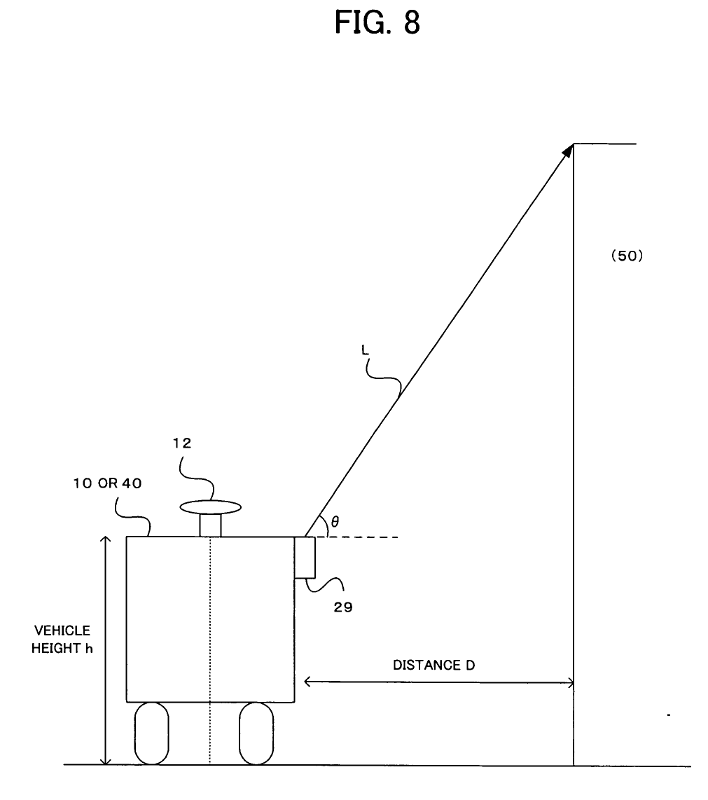

Next, the third embodiment of the present invention will be explained. FIG. 8 is a diagram schematically showing a measurement state of the vehicle-type measurement system according to the third embodiment of the present invention. The configuration of the vehicle-type measurement system of this embodiment is identical to that one according to the first embodiment. In addition, the system can measure height of a building 50 neighboring the traveling position. As shown in FIG. 8, the light source 29 which irradiates the light L in an oblique upward direction is attached, and the light L is emitted to the top of the building 50 subjected to the measurement. The light source 29 includes the optical system as well as the light source 28 shown in FIG. 2, and displays a state of the light L which is irradiated on the top of the building on the screen 18. Thereby, the vehicle-type measurement system is driven so that the light L is always irradiated to the top of the building 50 and the vehicle-type measurement system travels at the position of the predetermined distance D remote from the building.

Since an angle θ that the light source 29 emits the light L is obtained by detecting an emission angle of the light emission unit of the light source 29, the height H of the building can be calculated by an equation: H=h+D·tan θ,if it is prescribed that the height of the light source 29 on the vehicle-type measurement system is “h”.

The reflected light of the light L which is irradiated to the building from the light source 29 can be received and projected on the map in the vehicle-type measurement system via an optical fiber, etc. In guiding the reflected light from the building 50 into the vehicle-type measurement system by utilizing a telescope with the light source 29, a positional deviation between an optical axis and a central axis of the telescope can be ignored in a case that the distance D between the vehicle-type measurement system and the building 50 is large. It is noted that a deviation quantity has to be calculated in a case that the distance D cannot be ignored.

In that way, by traveling the vehicle-type measurement system along the position with a predetermined distance from the building and the light L from the light source is always irradiated to the top of the building 50, the height of the building 50 can be obtained. The measurement method of the height of the building according to the third embodiment can be applied to the vehicle-type measurement systems 10 and 40 according to the first and second embodiments.

As explained above, according to the present invention, by traveling the vehicle-type measurement system so that the light L from the light source is irradiated to the predetermined target such as a road edge, highly accurate measurement data of the target position or the position within the predetermined distance from the target position can be obtained. The data can be utilized as auxiliary data in producing the highly accurate map data. Also, when the vehicle travels without grasping a road position, such as the snow removal work in a snowfall area, the vehicle can travel at a correct position according to pre-measured traveling data.

1. A vehicle-type measurement system comprising:
a light source which irradiates a light to a target position while traveling;
a screen which displays a position of the irradiated light to the target position;
a GPS antenna;
a GPS receiver which is connected to the GPS antenna and outputs GPS measurement data; and
a data storing unit which stores the GPS measurement data output from the GPS receiver in a storage medium.

2. The vehicle-type measurement system according to claim 1, further comprising a correction data receiver which receives correction data of the GPS measurement data, wherein the GPS receiver corrects the GPS measurement data by utilizing the correction data.

3. The vehicle-type measurement system according to claim 1, further comprising:
a display device which displays map data in a neighborhood of a current position of the vehicle-type measurement system; and
a measurement position display unit which displays a measurement position, based on the GPS measurement data, on the display device.

4. The vehicle-type measurement system according to claim 1, wherein the data storing unit stores the GPS measurement data in the storage medium in a manner associated with place name.

5. The vehicle-type measurement system according to claim 1, further comprising an image-capturing device which captures a neighboring image, wherein the data storing unit stores image data captured by the image-capturing device in the storage medium in a manner associated with the GPS measurement data.

6. A vehicle-type measurement system comprising:
a light source which irradiates a light to a top of a target object while traveling;
a screen which displays a position of the irradiated light to the top of the target object;
an angle detection unit which detects an emission angle of the light; and
a calculation unit which calculates height of the target object based on the emission angle, a distance between the vehicle-type measurement system and the target object, and height of the vehicle-type measurement system.

7. The vehicle-type measurement system according to claim 6, further comprising:
a GPS antenna;
a GPS receiver which is connected to the GPS antenna and outputs GPS measurement data; and
a data storing unit which stores GPS measurement data output from the GPS receiver in a storage medium, together with the calculated height of the target object.
